(19) United States
(12) Patent Application Publication
(10) Pub. No.: US 2005/0230956 A1
(43) Pub. Date: Oct. 20, 2005

(54) Automatic bookmark

(76) Inventor: Harutoshi Igeta, Osaka (JP)

Correspondence Address: RABIN & Berdo, PC, 1101 14TH STREET, NW, SUITE 500, WASHINGTON, DC, 20005, US

(21) Appl. No.: 10/515,071

(22) PCT Filed: Jun. 2, 2003
(86) PCT No.: PCT/JP03/06966

§ 371 Date: Nov. 19, 2004

(30) Foreign Application Priority Data
Jun. 5, 2002 (JP) 2002-163874

(51) Int. Cl. B42D 9/00

(52) U.S. Cl. 281/42

(57) ABSTRACT

An automatic bookmark (1) is composed of a quadrangular base sheet (5), a pair of coupling bodies (6a, 6b) provided on one edge of the base sheet (5), a projecting body (13) provided between the coupling bodies (6a, 6b), elastic bodies (12a, 12b) connected on upper sides (29a, 29b) which are the forward ends of the pair of coupling bodies (6a, 6b) and provided with crease lines (15) in parallel with the upper sides (29a, 29b) and a V-shaped bookmark body (27) connected to the forward ends of the elastic bodies (12a, 12b) to oppose the base sheet (5). In use, this base sheet (5) is put between page sheets of a book, for holding a proper volume of page sheets between the base sheet (5) and the bookmark body (27). Thus, a side of the bookmark body (27) close to the fore edge of the book necessarily becomes a tilting inclining side (11a). Therefore, a turned page sheet comes into contact with the inclining side (11a), so that the bookmark body (27) is smoothly flapped up.

### TECHNICAL FIELD

The present invention relates to an automatic bookmark, and more particularly, it relates to an automatic bookmark automatically put between two facing pages every time any page of a book is turned.

### BACKGROUND TECHNIQUE

FIG. 9 is a general view of a conventional automatic bookmark.

Referring to the figure, the automatic bookmark 50 is composed of a base sheet 5 formed by a quadrangular synthetic resin sheet, a projecting portion 54 provided to outwardly project from a side of the base sheet 5 and a strip-shaped bookmark body 51 of synthetic resin thermally welded to the projecting portion 54. The base sheet 5, made of synthetic resin such as polyethylene or polypropylene, is elastic and flexibly bendable. The projecting portion 54 is a part of the base sheet 5, and the bookmark body 51 is made of synthetic resin such as polyethylene or polypropylene. Therefore, the same has elasticity as well as flexibility. This bookmark body 51 is thermally welded to the projecting portion 54 at a fixing portion 53 on one end, while the other end is elongated toward the base sheet 5 and mounted to face the base sheet 5. The bookmark body 51 has an elastic body 52 in the vicinity of the fixing potion 53, and this elastic body 52 is colored while the remaining portion is achromatic and transparent.

The use of this automatic bookmark is now described.

FIG. 10 is a general view showing a state of putting the aforementioned automatic bookmark between pages of a book, FIG. 11 is a front elevational view showing the book holding this automatic bookmark from a fore edge direction, FIG. 12 is a diagram showing a state of turning a page sheet of the book holding this automatic bookmark, and FIG. 13, a diagram corresponding to FIG. 12, is an enlarged view around the bookmark body.

Referring to these figures, the automatic bookmark 50 is set by putting the base sheet 5 between the pages of the book, largely flapping up the bookmark body 51, then superposing a proper volume of page sheets 17 on the base sheet 5 and thereafter returning the bookmark body 51. When the automatic bookmark 50 is put in this manner, the projecting portion 54 projects from an upper surface 20 of the book, and the bookmark body 51 hangs down from the projecting portion 54 toward the page surface. While it follows that the bookmark body 51 covers one of the facing pages at this time, reading of the page surface is not hindered since the covering portion is transparent.

The reader reads the facing pages in this state, and turns a page sheet 17 after completely reading the same. Then, as shown in FIG. 13, an upper side 25 of the page sheet 17 comes into contact with a lateral side 55a close to the fore edge 18 (see FIG. 12) of the bookmark body 51. When the reader further turns the page sheet 17 up to a position shown by two-dot chain lines, the point in contact with the bookmark body 51 moves from a contact 56 to another contact 57 toward the backbone 19 (see FIG. 12). Following this, the bookmark body 51 is flapped up to a position shown by other two-dot chain lines. When the reader further turns the page sheet 17, the forward end of the bookmark body 51 passes the upper side 25 of the page sheet 17. When passing this point, the bookmark body 51 returns to the original position by elastic force and covers the surface of one of new facing pages.

Thus, the bookmark body 51 automatically moves when the reader simply ordinarily reads the book 16. When the reader stops reading and closes the book 16, it follows that the bookmark body 51 is regularly put between the final pages read by the reader.

High resistance is easily applied to the aforementioned conventional automatic bookmark since the bookmark body is flapped directly upward when the reader turns the page sheet. When the automatic bookmark is set in a book and any page sheet is turned, therefore, the page sheet may not be smoothly turnable.

The present invention has been proposed in order to solve the aforementioned problem, and aims at providing an automatic bookmark allowing the user to smoothly turn a page sheet with no resistance.

### DISCLOSURE OF THE INVENTION

In order to attain the aforementioned object, an automatic bookmark according to a first aspect of the present invention is an automatic bookmark put between pages of a book, comprising a sheetlike base sheet, an elastic body provided on an edge of the base sheet and a sheetlike bookmark body connected to the elastic body through a connecting side to extend on a position opposing the base sheet, and a side of the bookmark body extending from one end of the connecting side inclines toward the other end of the connecting side with respect to a surface orthogonal to the connecting side from the one end.

According to this structure, it follows that the inclining side of the bookmark body and an upper side of a page sheet come into contact with each other and the bookmark body is flapped up when the page sheet is turned if the automatic bookmark is so set as to locate the inclining side of the bookmark body on the side of the fore edge of a book.

In the automatic bookmark according to a second aspect of the present invention, the bookmark body is in the form of an isosceles-triangular sheet whose base is connected to the connecting side of the base sheet in the structure of the present invention according to the first aspect.

According to this structure, it follows that the side of the bookmark body located close to the fore edge regularly inclines inward whether the automatic bookmark is set in a rightwardly or leftwardly opened book. Therefore, it follows that the inclining side of the bookmark body and an upper side of a page sheet necessarily come into contact with each other and the bookmark body is flapped up when the page sheet is turned.

An automatic bookmark according to a third aspect of the present invention is an automatic bookmark put between pages of a book, comprising a sheetlike base sheet, a pair of elastic bodies connected to the respective ones of positions separated from each other by a prescribed distance on an edge of the base sheet and a V-shaped sheetlike bookmark body, connected to the respective ones of the elastic bodies, extending toward positions opposing the base sheet.

According to this structure, it follows that the side of the bookmark body located close to the fore edge regularly inclines inward whether the automatic bookmark is set in a rightwardly or leftwardly opened book. Therefore, it follows that the inclining side of the bookmark body and an upper side of a page sheet necessarily come into contact with each other and the bookmark body is flapped up when the page sheet is turned. Further, the respective ones of bookmark pieces constituting the respective sides of the V shape are bonded to each other only on the forward ends. Therefore, mutual movements of the respective bookmark pieces are relatively free. When the page sheet is turned, therefore, one of the bookmark pieces coming into contact with the upper side of the page sheet is flapped up in advance and the other bookmark piece is flapped up in a delayed manner.

In the automatic bookmark according to a fourth aspect of the present invention, the elastic bodies are provided with at least single crease lines parallel to a line connecting the respective ones of the positions with each other in the structure of the present invention according to the third aspect.

According to this structure, it follows that the elastic bodies keep states bent on the portions of the crease lines. When the elastic bodies are so folded through the crease lines that the base sheet and the bookmark body parallelly oppose each other, therefore, it follows that the parallel state is stably maintained.

In the automatic bookmark according to a fifth aspect of the present invention, the base sheet has two coupling bodies projecting from one side thereof, and the respective ones of the elastic bodies are connected to the forward ends of the respective ones of the coupling bodies in the structure of the present invention according to the third aspect or the fourth aspect.

According to this structure, it follows that the elastic bodies are located on portions separating from a reference side of the base sheet by the coupling bodies. Thus, the elastic bodies project from the upper surface of a book even if sides of the coupling bodies and the upper surface of the book are rendered flush with each other when the automatic bookmark is set in the book.

In the automatic bookmark according to a sixth aspect of the present invention, the base sheet, the elastic bodies and the bookmark body are formed by folding a synthetic resin sheet in the structure of the present invention according to the third aspect to the fifth aspect.

According to this structure, the automatic bookmark can be manufactured from a single sheet.

As hereinabove described, the inclining side of the bookmark body and an upper side of a page sheet come into contact with each other when the automatic bookmark is set in a book and the page sheet is turned in the automatic bookmark according to the first aspect. The bookmark body is flapped up by force for turning this page sheet. Thus, force for flapping up the bookmark body may be weak since the side of the bookmark body inclines. Therefore, the page sheet can be smoothly turned since the force for turning the page sheet may also be weak.

In the automatic bookmark according to the second aspect of the present invention, it follows that the side of the bookmark body located close to the fore edge regularly inclines inward when the automatic bookmark is set in a book regardless of whether the book is rightwardly or leftwardly opened, in addition to the effect according to the first aspect of the present invention. Thus, it is possible to cope with both of rightwardly and leftwardly opened books with a single automatic bookmark, whereby it is not necessary to prepare two types of automatic bookmarks.

In the automatic bookmark according to the third aspect of the present invention, it follows that the side of the bookmark body located close to the fore edge necessarily inclines inward when the automatic bookmark is set in a book regardless of whether the book is rightwardly or leftwardly opened, since the bookmark body of the automatic bookmark is V-shaped. Thus, it is possible to cope with both of rightwardly and leftwardly opened books with a single automatic bookmark, whereby it is not necessary to prepare two types of automatic bookmarks. When this automatic bookmark is put between pages of the book and a page sheet is turned, the inwardly inclining side of the bookmark body and the upper side of the page sheet flap up the bookmark body while coming into contact with each other. Since the respective ones of the bookmark pieces constituting the respective sides of the V shape can relatively freely move at this time, the bookmark piece coming into contact with the page sheet is flapped up in advance and the other one is flapped up in a delayed manner. Thus, a side of the bookmark body is brought into a state simply twisted with weak force when force is applied thereto. Therefore, force for flapping up the bookmark body may be weak. Thus, force for turning the page sheet may be weaker, and the operation of turning the page sheet is smoothed. Thus, the bookmark sheet is easy to handle.

The automatic bookmark according to the fourth aspect of the present invention forms the state where the base sheet and the bookmark body are parallel to each other by forming the crease lines in the elastic bodies, in addition to the effect according to the third aspect of the present invention. Therefore, this form is stably maintained. Thus, no crease disappears even if the bookmark body is repeatedly flapped up but the state where the base sheet and the bookmark body are parallel to each other can be kept long. Therefore, durability of the automatic bookmark is improved.

In the automatic bookmark according to the fifth aspect of the present invention, the elastic bodies project from the upper surface of a book even if sides of the coupling bodies and the upper surface of the book are rendered flush with each other when the automatic bookmark is set in the book, in addition to the effect according to the third aspect or the fourth aspect of the present invention. Therefore, the position of the bookmark body is easy to visually recognize when reading is stopped and the book is closed. On the other hand, the reference side of the base sheet can be set not to project from the upper surface of the book by the height of the coupling bodies, whereby the automatic bookmark is easy to handle.

The automatic bookmark according to the sixth aspect of the present invention is easily to manufacture and the manufacturing cost is reduced since the bookmark body is formed by a single sheet, in addition to the effects according to the third aspect to the fifth aspect of the present invention.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a general view showing the structure of an automatic bookmark according to a first embodiment of the present invention.

FIG. 2 is a front elevational view of a book holding the automatic bookmark shown in FIG. 1 as viewed from a fore edge direction.

FIG. 3 is a diagram showing a state of turning a page sheet of the book holding the automatic bookmark shown in FIG. 1.

FIG. 4, a diagram corresponding to FIG. 3, is an enlarged view of a portion around a bookmark body.

FIG. 5 are model diagrams showing a state of setting the automatic bookmark shown in FIG. 1 in the book and turning the page sheet, (1) thereof is a diagram as viewed from above the book, and (2) thereof is a diagram as viewed from the fore edge direction of the book.

FIG. 6 is a general view showing the structure of an automatic bookmark according to a second embodiment of the present invention.

FIG. 7 is a partially enlarged diagram around a bookmark body showing a state of setting the automatic bookmark shown in FIG. 6 in a book and turning a page sheet.

FIG. 8 is a general view showing the structure of an automatic bookmark according to a third embodiment of the present invention.

FIG. 9 is a general view of a conventional automatic bookmark.

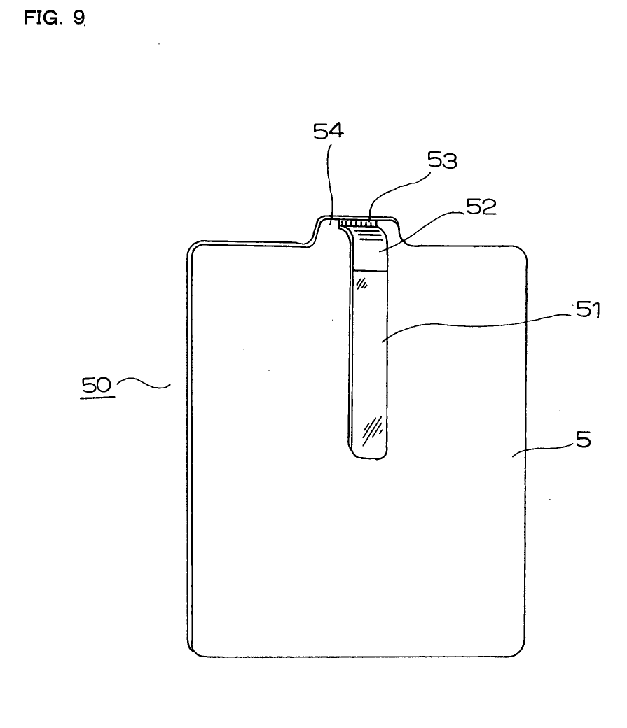

FIG. 10 is a general view showing a state of putting the automatic bookmark shown in FIG. 9 between the pages of a book.

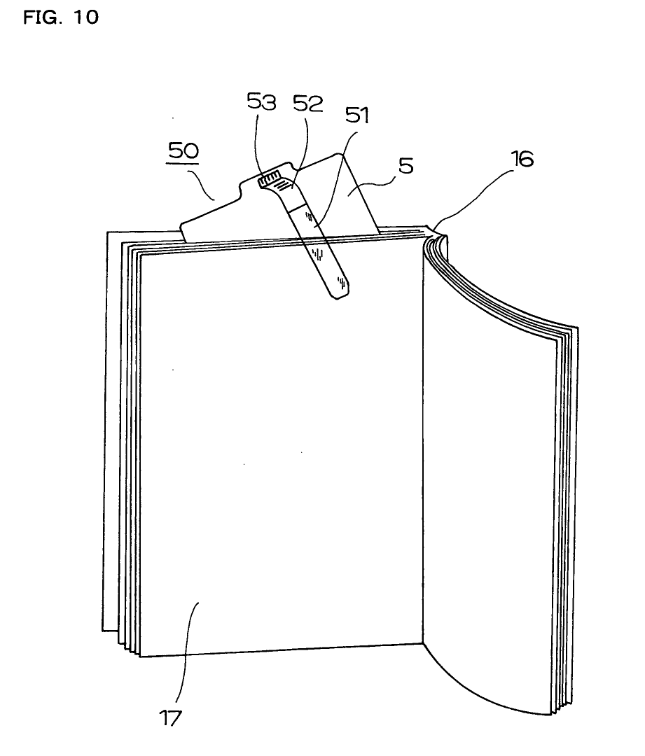

FIG. 11 is a front elevational view of the book holding the automatic bookmark shown in FIG. 9 as viewed from the fore edge direction.

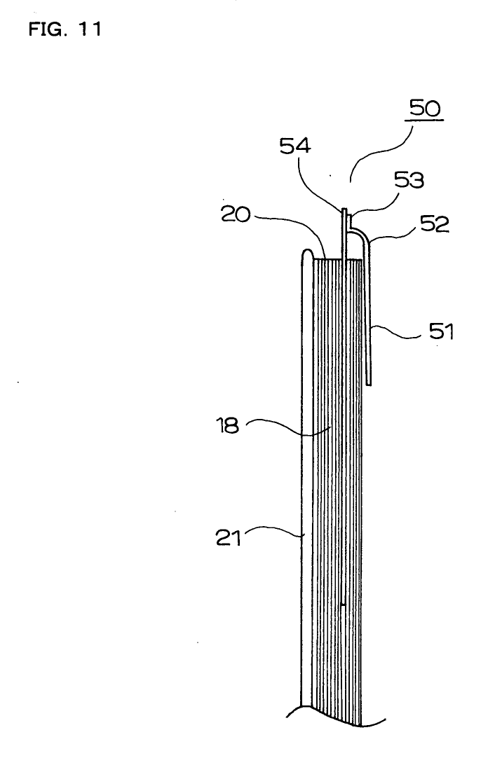

FIG. 12 is a diagram showing a state of turning a page sheet of the book holding the automatic bookmark shown in FIG. 9.

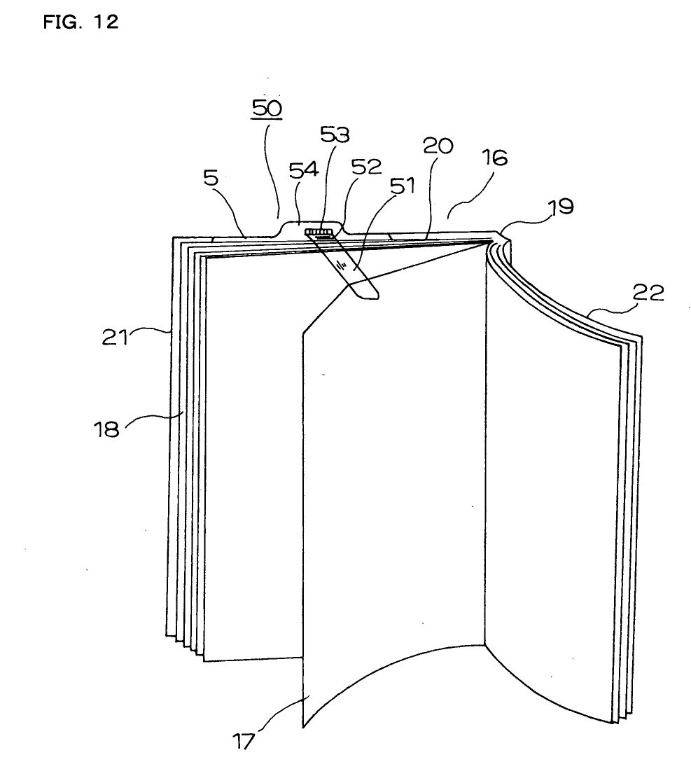

FIG. 13, a diagram corresponding to FIG. 12, is an enlarged view around a bookmark body.

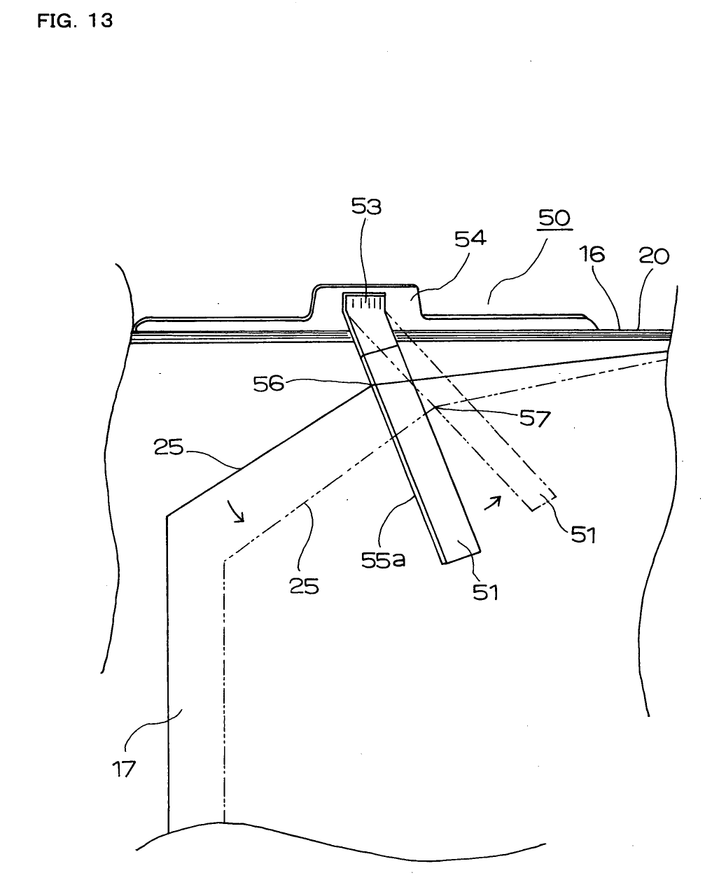

### BEST MODES FOR CARRYING OUT THE INVENTION

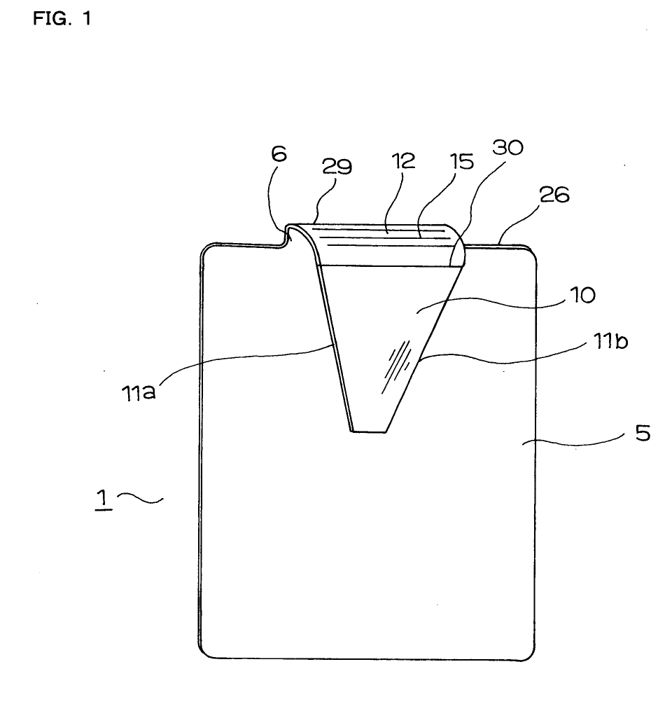

FIG. 1 is a general diagram showing the structure of an automatic bookmark according to a first embodiment of the present invention.

Referring to the figure, the automatic bookmark 1 is composed of a base sheet 5 in the form of a quadrangular sheet, a coupling body 6 projecting outward from a side of the base sheet 5, an elastic body 12 connected to an upper side 29 which is the forward end of the coupling body 6 and bent by forming a plurality of crease lines 15 in parallel with the upper side 29 and a bookmark body 10 which is an isosceles-triangular sheet connected to an end of the elastic body 12 on a connecting side 30 which is the base thereof. This automatic bookmark 1 is formed by punching and folding a sheet of synthetic resin. This synthetic resin sheet has elasticity in a bent state and can be easily folded since polyethylene, polypropylene, etc. is used therefor.

In manufacturing, the base of the bookmark body 10 is folded along the side substantially perpendicularly to the coupling body 6 with the plurality of crease lines 15 formed in the vicinity of the base of the bookmark body 10 in parallel with the base, and so worked that the bookmark body 10 and the base sheet 5 substantially parallelly oppose each other. The bookmark body 10 is achromatic and transparent, while the elastic body 12 and the base sheet 5 are colored or provided with patterns.

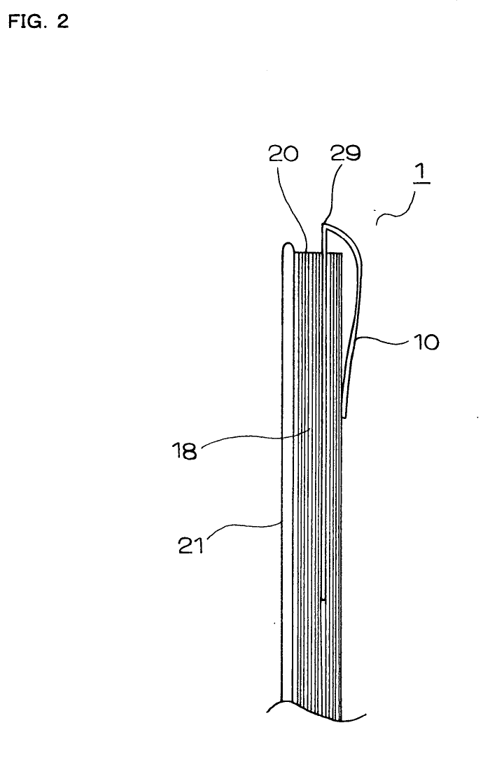

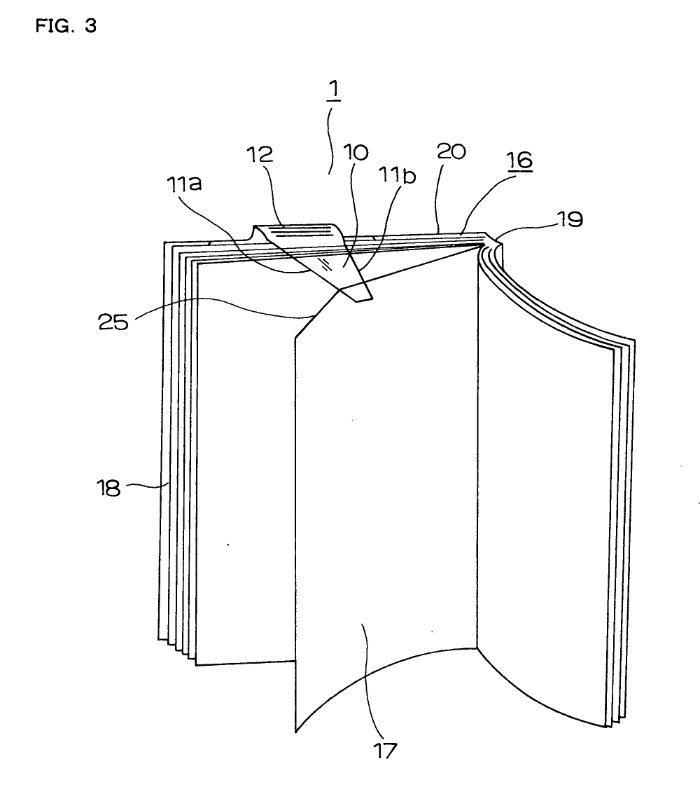

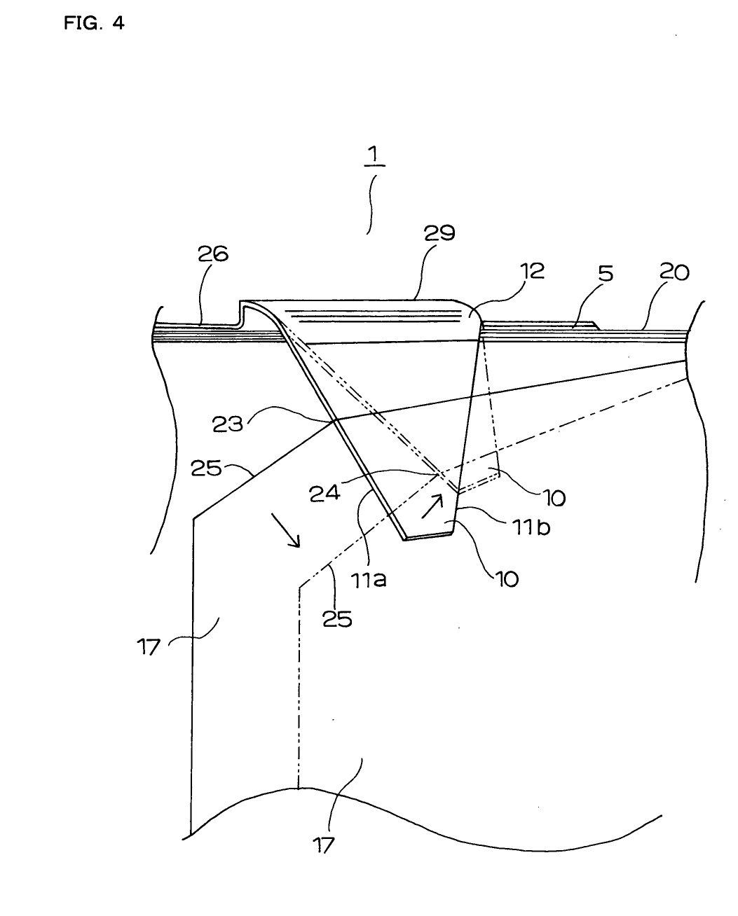

FIG. 2 is a diagram of a book holding the automatic bookmark of FIG. 1 as viewed from the fore edge direction, FIG. 3 is a diagram showing a state of turning a page sheet of the book holding the automatic bookmark of FIG. 1, and FIG. 4, a diagram corresponding to FIG. 3, is an enlarged view around the bookmark body.

Referring to these figures, the automatic bookmark 1 is set in the book 16 by opening pages behind a page desired to be read by a proper volume and inserting and placing the base sheet 5 into a deep portion between the opened pages, so that the base sheet 5 is fixed between these pages not to easily drop. Then, the bookmark body 10 is largely flapped up, for superposing a proper volume of page sheets 17 on the base sheet 5 to locate the page to be read uppermost. Then, the bookmark body 10 is returned. At this time, the upper side 26 of the base sheet 5 is rendered substantially flush with the upper surface 20 of the book 16.

According to this, the coupling body 6 and the elastic body 12 project from the upper surface 20 of the book 16, and the bookmark body 10 is brought into a state substantially parallelly opposing the surface of any page sheet 17. Thus, the position where the bookmark body 10 is held can be easily visually recognized when the book 16 is closed. On the other hand, the automatic bookmark is easy to handle since the same can be so set that the upper side 26 which is the reference side of the base sheet 5 does not project from the upper surface 20 of the book 16 by the height of the coupling body 6. While the bookmark body 10 covers the page sheet 17 when the book is read, the reading is not hindered since the same is transparent.

When the page sheet 17 of the book 16 in which the automatic bookmark 1 is set as shown in FIGS. 3 and 4, the upper side 25 of the page sheet 17 and an inclining side 11a of the bookmark body 10 come into contact with each other at a contact 23. When the page sheet 17 is turned from this position to a position shown by two-dot chain lines, the contact point moves to a contact 24. Following this, the bookmark body 10 is flapped up to a position shown by other two-dot chain lines. The page sheet 17 is further turned until the forward end of the bookmark body 10 passes the upper side 25 of the page sheet 17. When the forward end of the bookmark body 10 passes the upper side 25 of the page sheet 17, the bookmark body 10 having been flapped up returns to the original state.

The reason why the page sheet 17 can be easily turned when the side of the bookmark body 10 is inclined is now described.

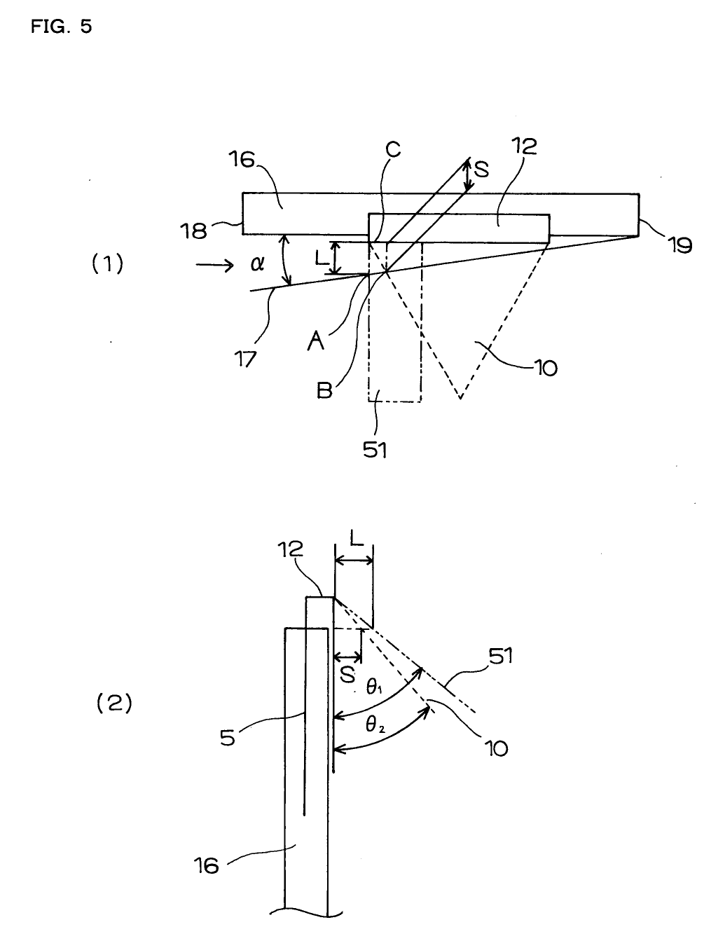

FIG. 5 are model diagrams showing a state of setting the aforementioned automatic bookmark in the book and turning the page sheet, (1) thereof is a diagram as viewed from above the book and (2) thereof is a diagram as viewed from the fore edge direction of the book. These figures show the conventional bookmark body 51 in two-dot chain lines while showing the bookmark body 10 according to the first embodiment of the present invention in broken lines.

Referring to these figures, the conventional bookmark body 51 horizontally separates by a distance L from the surface of the bookmark body 51 present on the original position parallel to the base sheet 5 to a point A where the upper side 25 of the page sheet 17 and the lateral side 55a of the bookmark body 51 come into contact with each other when the page sheet 17 of the book 16 is turned. On the other hand, the bookmark body 10 according to the present invention horizontally separates by a distance S from the surface of the bookmark body 10 present on the original position parallel to the base sheet 5 to a point B where the upper side 25 of the page sheet 17 and the inclining side 11a of the bookmark body 10 come into contact with each other when the page sheet 17 is identically turned. At this time, the distance S is shorter than the distance L as obvious from the figures.

When observing this state from the fore edge side, the conventional bookmark body 51 is flapped up to an angle θ1 while the bookmark body 10 according to the present invention is flapped up to an angle θ2 smaller than the angle θ1 if the page sheet 17 is identically turned. In other words, it follows that the bookmark body 10 according to the present invention is less flapped up and consequently requires smaller turning force when the page sheet 17 is identically turned.

As to the distances of movements from a point C to the point B indicating the movement of the contact between the page sheet 17 and the inclining side 11a of the bookmark body 10 and from the point C to the point A indicating the movement of the contact between the page sheet 17 and the lateral side 55a of the bookmark body 51, that of the bookmark body 10 according to the present invention is longer. While the flap-up angles of the bookmark bodies 10 and 51 are finally equalized with each other when the forward ends of the bookmark bodies 10 and 51 pass the page sheet 17, the bookmark body 10 according to the present invention exhibits a larger angle α for turning the page sheet 17 at this time. In other words, the bookmark body 10 according to the present invention exhibits a longer distance of movement for turning the page sheet 17 since the bookmark bodies 10 and 51 are flapped up to the same height, whereby force applied for turning the page sheet 17 may be small.

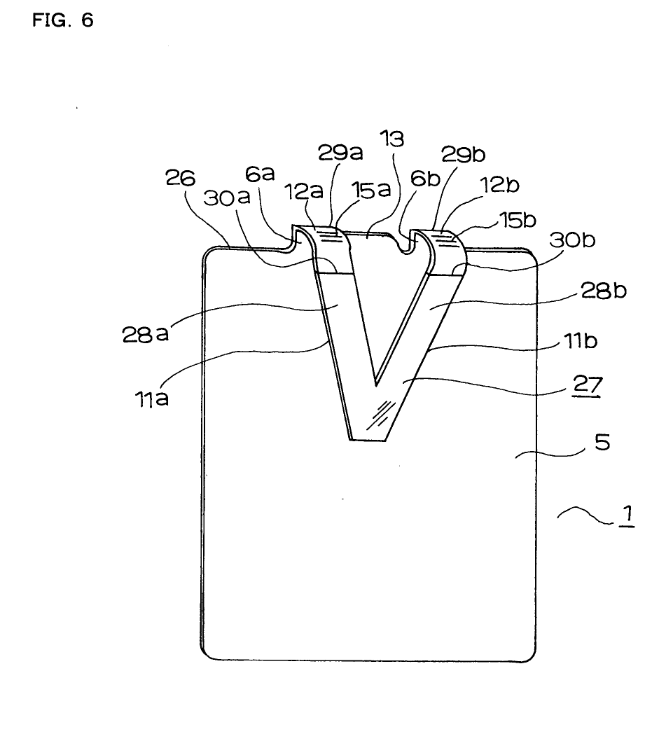

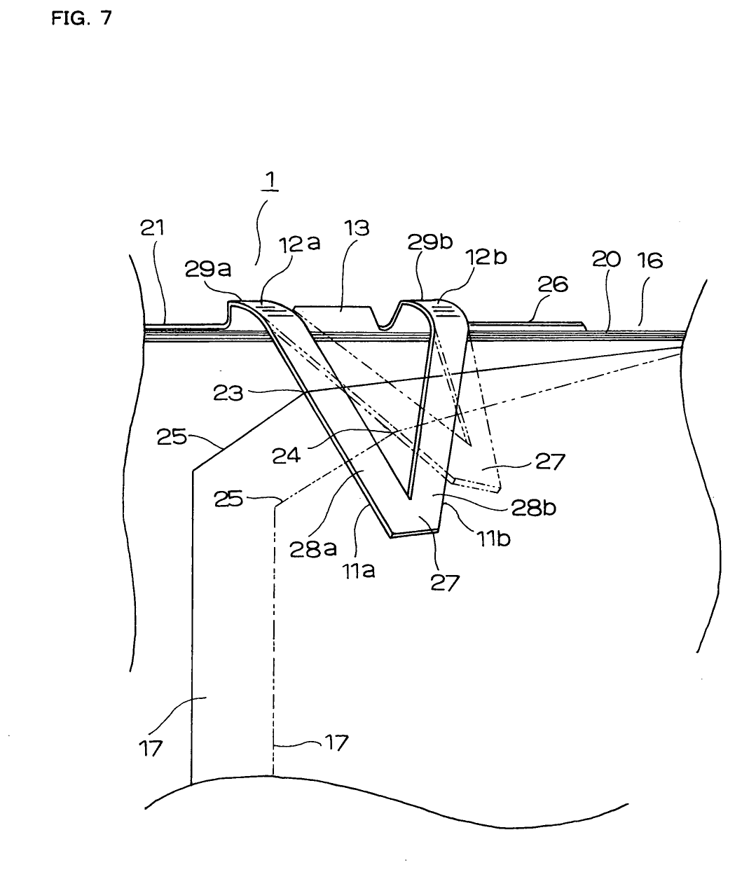

FIG. 6 is a general view of an automatic bookmark showing a second embodiment of the present invention, and FIG. 7 is a partially enlarged view around a bookmark body showing a state of setting this automatic bookmark in a book and turning a page sheet.

Referring to these figures, the automatic bookmark 1 is constituted of a quadrangular base sheet 5, a pair of coupling bodies 6a and 6b projectingly provided on a side of the base sheet 5, a projecting body 13 provided to be held between the pair of coupling bodies 6a and 6b, a pair of elastic bodies 12a and 12b connected on upper sides 29a and 29b which are the forward ends of the respective coupling bodies 6a and 6b and folded with a plurality of crease lines 15a and 15b formed in parallel with the upper sides 29a and 29b and a bookmark body 27 formed by bonding a pair of bookmark pieces 28a and 28b connected to the forward ends of the respective elastic bodies 12a and 12b through connecting sides 30a and 30b on the forward ends and brought into the form of a V-shaped sheet. This automatic bookmark 1 is formed by punching a single synthetic resin sheet, similarly to the automatic bookmark 1 shown in the first embodiment.

In manufacturing, the elastic bodies 12a and 12b are formed by substantially perpendicularly folding the upper sides 29a and 29b which are connecting portions between the V-shaped bookmark body 27 and the coupling bodies 6a and 6b, further folding the same oppositely to the coupling bodies 6a and 6b in the vicinity of the upper sides 29a and 29b and forming the plurality of crease lines 15a and 15b in parallel with the upper sides 29a and 29b. The bookmark body 27 is worked to substantially parallelly oppose the base sheet 5 through these crease lines 15a and 15b. While the bookmark body 27 covers the surface of a page sheet 17 at this time, reading is not hindered since the bookmark body 27 is achromatic and transparent. The base sheet 5 and the elastic bodies 12a and 12b are colored or provided with patterns.

The automatic bookmark 1 is set in a book 16 similarly to the first embodiment.

In other words, the base sheet 5 is superposed on facing pages of the book 16, for placing a proper volume of page sheets 17 and superposing the bookmark body 27 thereon. When any page sheet 17 of the book 16 in which this automatic bookmark 1 is set is turned, an inclining side 11a of the bookmark piece 28a located close to the fore edge of the book 16 comes into contact with an upper side 25 of the page sheet 17. Thus, the bookmark piece 28a forming one side of the V shape is flapped up first. The other bookmark piece 28b, connected only on the forward end of the V shape, is continuously subjected to transmission of force through this forward end and flapped up. Thus, this bookmark piece 28b is flapped up in a delay from the bookmark piece 28a coming into contact with the page sheet 17, whereby the overall V-shaped bookmark body 27 is brought into a twisted form.

Thus, the V-shaped bookmark body 27 is twisted since the upper side 25 of the page sheet 17 comes into contact with the inclining side 11a. Therefore, force for flapping up the V-shaped bookmark body 27 may be small, whereby force for turning the page sheet 17 may also be weak and the operation thereof is smooth. Since the coupling bodies 6a and 6b are provided, it follows that the elastic bodies 12a and 12b are located upward beyond the upper surface 20 of the book 16 also when an upper side 26 which is the reference side of the base sheet 5 is located downward beyond the upper surface 20 of the book 16 by the coupling bodies 6a and 6b.

The automatic bookmark 1 is so constituted that the upper sides 29a and 29b which are connecting portions between the coupling bodies 6a and 6b and the elastic bodies 12a and 12b are flush with the upper surface 20 of the book 16 when the upper side of the projecting body 13 provided between the coupling bodies 6a and 6b is rendered flush with the upper surface 20 of the book 16. Thus, adjustment of the automatic bookmark 1 is simplified when the same is set with the projecting body 13. Further, the elastic bodies 12a and 12b are so folded that the crease lines 15 do not disappear also when the page sheet 17 is repeatedly turned. Thus, the automatic bookmark 1 has durability.

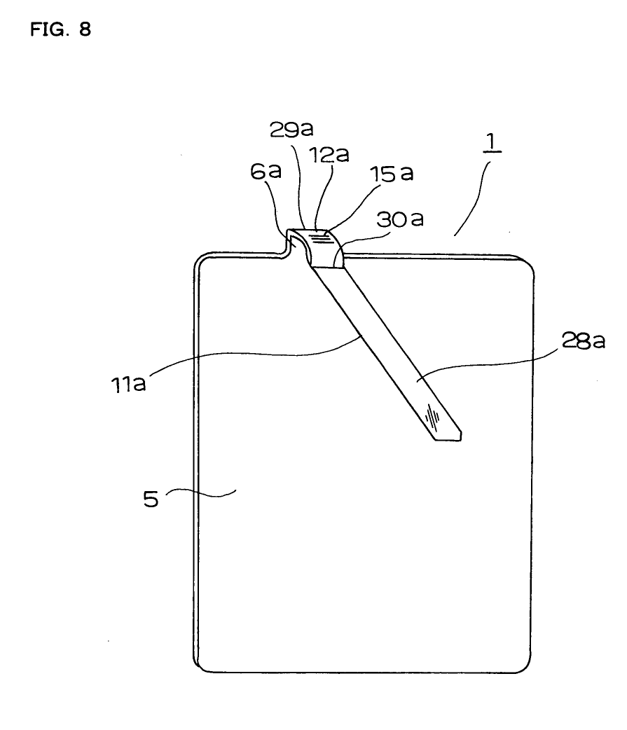

FIG. 8 is a general view of an automatic bookmark showing a third embodiment of the present invention.

Referring to the figure, this automatic bookmark 1 according to the third embodiment corresponds to a shape obtained by omitting the bookmark piece 28b constituting one side of the V-shaped bookmark body 27 of the automatic bookmark 1 according to the second embodiment shown in FIG. 6.

While the V-shaped bookmark body 27 according to the second embodiment has a shape corresponding to a rightwardly or leftwardly opened book, the automatic bookmark 1 according to this embodiment is used dedicatedly to a rightwardly opened book. As that dedicated to a leftwardly opened book, the bookmark piece 28a of the automatic bookmark 1 shown in FIG. 6 may be omitted for employing the bookmark piece 28b. When this automatic bookmark 1 is set in a rightwardly opened book 16 and a page sheet is turned, an inclined side 11a of a bookmark piece 28a and the upper side of the page sheet necessarily come into contact with each other. When the bookmark piece 28b of the V-shaped bookmark body 27 shown in FIG. 6 is thus removed, the bookmark piece 28a can be flapped up with weaker force since only one side is flapped up. Thus, the force for turning the page sheet may be weaker.

While the isosceles-triangular bookmark body is employed in the aforementioned first embodiment, this also has a shape corresponding to a rightwardly or leftwardly opened book. When the direction for opening the book is limited, therefore, only one corresponding side may incline. Therefore, the shape of the bookmark body may be a right-triangular shape rendering the side close to the backbone perpendicular.

While folding is performed by punching a single sheet in each of the aforementioned embodiments, the molding method may not be restricted to this but integral molding can be performed with synthetic resin, for example.

While the crease lines are formed in the elastic bodies in each of the aforementioned embodiments, bending may alternatively be performed in curved shapes. When heat is applied in bending for keeping bent shapes in this case, durability is further improved.

While the coupling bodies are provided between the base sheet and the elastic bodies in the aforementioned embodiment, the elastic bodies may alternatively be directly connected from the upper side of the base sheet. In this case, the automatic bookmark may be set and used so that the upper side of the base sheet and the upper surface of the book are flush with each other.

While the coupling bodies are provided to project from the upper side of the base sheet in each of the aforementioned embodiments, the base sheet itself may alternatively be constituted to include a coupling body shape.

Although the present invention has been described and illustrated in detail, it is clearly understood that the same is by way of illustration and example only and is not to be taken by way of limitation, the spirit and scope of the present invention being limited only by the terms of the appended claims.

### INDUSTRIAL AVAILABILITY

As hereinabove described, the automatic bookmark according to the present invention is suitable for an apparatus automatically inserting the bookmark also when a half-read book is closed as such.

1. An automatic bookmark put between pages of a book, comprising:
a sheetlike base sheet (5);
an elastic body (12) provided on an edge of said base sheet; and
a sheetlike bookmark body (10) connected to said elastic body through a connecting side (30) to extend on a position opposing said base sheet, wherein
a side of said bookmark body extending from one end of said connecting side inclines toward the other end of said connecting side with respect to a surface orthogonal to said connecting side from said one end.

2. The automatic bookmark according to claim 1, wherein said bookmark body is in the form of an isosceles-triangular sheet whose base is connected to said connecting side of said base sheet.

3. An automatic bookmark put between pages of a book, comprising:
a sheetlike base sheet (5);
a pair of elastic bodies (12a, 12b) connected to the respective ones of positions separated from each other by a prescribed distance on an edge of said base sheet; and
a V-shaped sheetlike bookmark body (27), connected to the respective ones of said elastic bodies, extending toward positions opposing said base sheet.

4. The automatic bookmark according to claim 3, wherein said elastic bodies are provided with at least single crease lines (15a, 15b) parallel to a line connecting the respective ones of said positions with each other.

5. The automatic bookmark according to claim 3, wherein said base sheet has two coupling bodies (6a, 6b) projecting from one side thereof, and the respective ones of said elastic bodies are connected to the forward ends of the respective ones of said coupling bodies.

6. The automatic bookmark according to claim 3, wherein said base sheet, said elastic bodies and said bookmark body are formed by folding a synthetic resin sheet.

7. The automatic bookmark according to claim 4, wherein said base sheet has two coupling bodies (6a, 6b) projecting from one side thereof, and the respective ones of said elastic bodies are connected to the forward ends of the respective ones of said coupling bodies.

8. The automatic bookmark according to claim 4, wherein said base sheet, said elastic bodies and said bookmark body are formed by folding a synthetic resin sheet.

9. The automatic bookmark according to claim 5, wherein said base sheet, said elastic bodies and said bookmark body are formed by folding a synthetic resin sheet.

10. The automatic bookmark according to claim 7, wherein said base sheet, said elastic bodies and said bookmark body are formed by folding a synthetic resin sheet.
